(19) United States
(12) Patent Application Publication
(10) Pub. No.: US 2009/0044022 A1
(43) Pub. Date: Feb. 12, 2009

(54) Secure verification system

(76) Inventor: Avtar Singh, Kirkby in Ashifield (GB)

Correspondence Address: HARRINGTON & SMITH, PC, 4 RESEARCH DRIVE, Suite 202, SHELTON, CT, 06484-6212, US

(21) Appl. No.: 12/228,200

(22) Filed: Aug. 11, 2008

(30) Foreign Application Priority Data
Aug. 11, 2007 (GB) 0715687.0

(51) Int. Cl. H04L 9/32

(52) U.S. Cl. 713/182

(57) ABSTRACT

A secure verification system 1 and a method of providing a secure verification system 1, the system 1 including a first user input terminal 5, a key generating device 29, a server 3 and a second user input terminal 7. The first user input terminal 5 enables a user to input at least three different types of personal identification information and transmit the input personal identification information to the server 3 for storage. The key generating device 29 generates and issues a key associated with the input personal identification information. The personal identification information and the information indicative of the key are stored at the server 3. The second user input terminal 7 enables the issued key to be authenticated and the stored personal identification information associated with the key to be retrieved from the server 3 and used to verify the identity of a user of the second user input terminal 7.

### FIELD OF THE INVENTION

The invention relates to a secure verification system. In particular it relates to a secure verification system where a plurality of different types of personal identification information are used to verify the identity of a user.

### BACKGROUND TO THE INVENTION

Verification systems are well known and are used in many different applications to confirm the identity of a person. Examples of situations in which it is useful to determine the identity of a person include, among other things, places of employment such as offices or factories where access is restricted to employees only or distribution systems where a driver collects goods from a first location and delivers them to a second location.

ID cards containing an image of the owner of the card are often used to verify the identity of a person. The verification of the identity of the owner of the card may be done manually by visually comparing the owner of the card and the image on the card. Problems with such systems can arise if a card is forged or falsified in any way.

Cards, such as swipe cards, which automatically grant a user access to a restricted area are also known. These cards may cause problems if they are lost or stolen as they could be used by an unauthorised person.

It would therefore be advantageous to provide a secure verification system which overcomes these problems.

### BRIEF DESCRIPTION OF THE INVENTION

According to the present invention there is provided a secure verification system comprising: a first user input terminal, the first user input terminal comprising a user input device for enabling a user to input at least three different types of personal identification information and a transceiver for transmitting the input personal identification information; a key generating device for generating and issuing a key associated with the input personal identification information wherein the key comprises information which is stored in a card which can be carried by a user of the verification system; a server, the server comprising a transceiver for receiving and transmitting the personal identification information and information indicative of the key, storage means for storing the received personal identification information and the information indicative of the key associated with the received personal identification information; and a second user input terminal comprising means for authenticating the issued key, means for retrieving the personal identification information associated with the key from the storage means and verification means for verifying the identity of the user of the second user input terminal using the personal identification information.

The key generating device may be comprised within the first user input terminal such that the key is generated at the first user input terminal and the transceiver of the first user input terminal may be operable to transmit information indicative of the generated key to the server.

Alternatively the key generating device may be comprised within the server such that the key is generated at the server and the transceiver of the first user input terminal may be operable to receive information indicative of the generated key from the server.

The personal identification information may include an image of the user of the first input terminal, a signature of the user of the first input terminal and at least one piece of biometric data of the user of the first input terminal.

The key may comprise information which is stored in a card which can be carried by a user of the verification system. In a first embodiment of the invention the key information is alphanumeric information such as an eight digit number which is printed on the card. In another embodiment of the invention the card comprises a magnetic strip which stores the key information.

The second user input terminal may also enable manual verification of the identity of the user.

The first user input terminal may be remote from the server. The second user input terminal may also be remote the server. The remote user input terminals may be connected to the server by a secure communications link.

The system may comprise a plurality of first user input terminals. The system may also comprise a plurality of second user input terminals.

The server may also comprise means for enabling administration of the system.

According to the present invention there is also provided a method of providing a secure verification system comprising; inputting at least three different types of personal identification information at a first terminal; generating and issuing a key associated with the input personal identification information wherein the key comprises information which is stored in a card which can be carried by a user of the verification system; transmitting the personal identification information and information indicative of the key to a server; storing the personal identification information and the information indicative of the associated key at the server; authenticating the key at a second terminal; and in response to the authentication of the key, retrieving the personal identification information associated with the key from the server and verifying the identity of the user of the second user input terminal using the retrieved information.

The key may be generated at the first terminal and information indicative of the key may be transmitted from the first terminal to the server. Alternatively the key may be generated at the server and information indicative of the key may be transmitted from the server to the first terminal.

According to a further embodiment of the present invention there is also provided a method of providing a secure verification system comprising: receiving, at least three types of personal identification information input at a first remote terminal; receiving information indicative of a key associated with the personal identification information and generated at the first remote terminal; storing the received information; detecting authentication of the key at a second remote terminal; and in response to the authentication of the key, retrieving the personal identification information associated with the key and transmitting it to the second terminal for verifying the identity of a user.

### BRIEF DESCRIPTION OF THE DRAWINGS

For a better understanding of the present invention reference will now be made, by way of example only, to the following drawings, in which;

FIG. 1 illustrates a secure verification system according to the present invention;

FIG. 2 illustrates a first user input terminal according to the present invention;

FIG. 3 illustrates a server according to the present invention;

FIG. 4 illustrates a second user input terminal according to the present invention; and

FIG. 5 illustrates a method of operating the secure verification system according to present invention.

### DETAILED DESCRIPTION OF EMBODIMENTS OF THE INVENTION

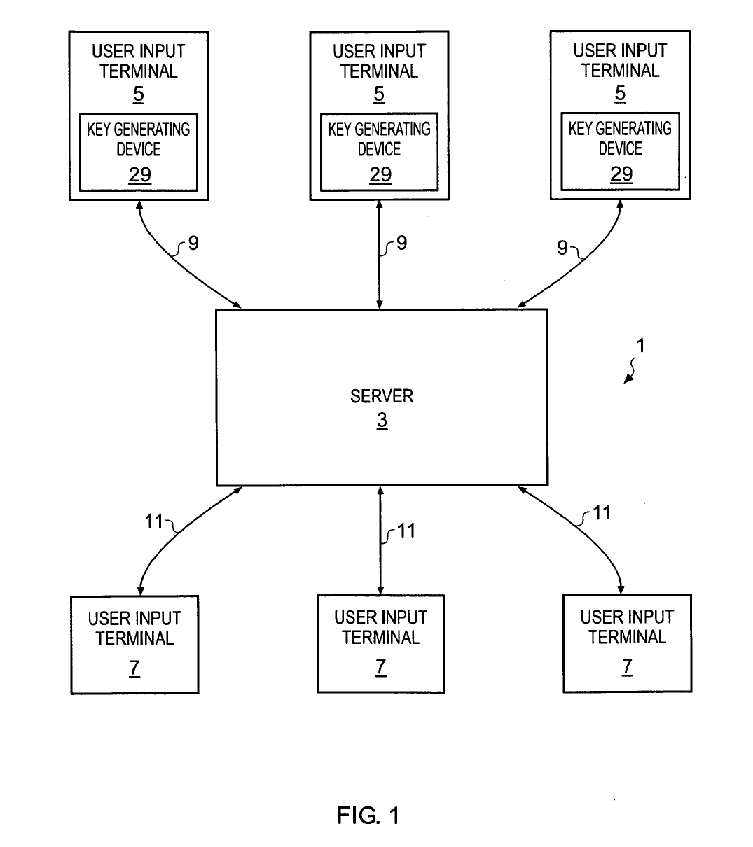

Referring to the FIG. 1 there is shown generally a secure verification system 1 comprising a central server 3, a plurality of first user input terminals 5, a plurality of key generating devices 29 and a plurality of second user input terminals 7.

The first user input terminals 5 and the second user input terminals 7 are located remote from the central server 3. For example, where the system 1 is implemented in a distribution system the central server 3 may be located in a central administration building, the first user input terminals 5 may be located within warehouses and the second user input terminals 7 may be located at any location within the distribution system which has access restrictions. The user input terminals 5, 7 may be on the same site as the central server 3 or may be at different locations around the country.

The user input terminals 5, 7 are operable to transmit and receive information from the central server 3 via a secure communications link 9, 11. The secure communications link 9, 11 may be, for example, the internet or an intranet connection.

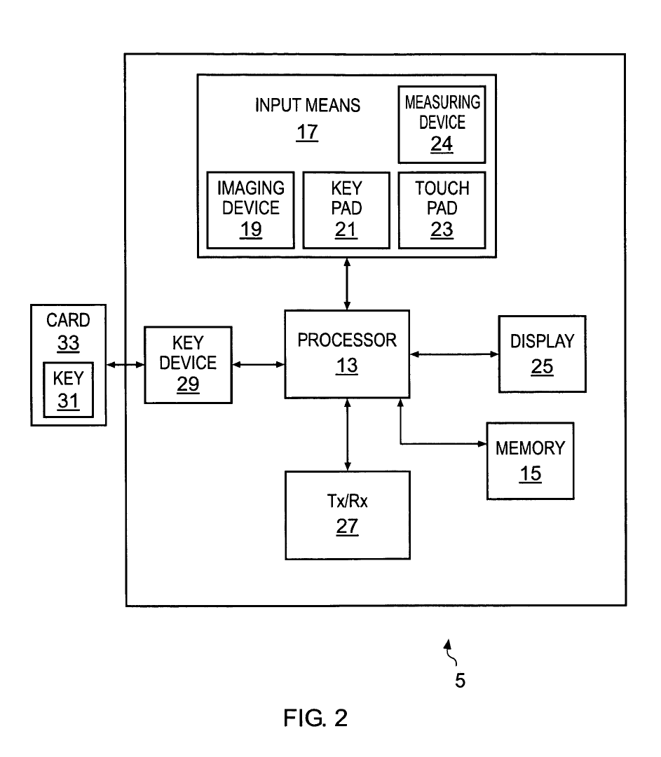

A first user input terminal 5 is illustrated schematically in more detail in FIG. 2. The first user input terminal 5 may be implemented within a specifically adapted kiosk or booth.

The first user input terminal 5 is operable to enable a user to input at least three different types of personal identification information. The personal identification information may be any information which enables the user of the first user input terminal to be uniquely identified. For example, the personal identification information may include the name and address of the user, an image of the user, a signature of the user, the height and weight and biometric data from the user such as a finger print, a hand print or an iris scan. In some embodiments the personal identification information will also include information obtained from a DNA sample of the user.

The first user input terminal 5 comprises a processor 13, a user input device 17, a display 25, a transceiver 27 and a key generating device 29.

The processor 13 is operable to control the first user input terminal 5. The processor 13 is arranged to send and receive inputs from the user input device 17, the display 25, the transceiver 27 and the key generating device 29.

The processor may also be operable to write to and read from a memory 15. The memory 15 may be operable to temporarily store information input using the input device 17. The memory 15 may also be operable to store computer program instructions for controlling the first user input terminal 5.

The user input device 17 enables a plurality of different types of personal identification information to be input into the first user input terminal 5.

The user input device 17 comprises an imaging device 19 which is operable to capture an image of the user of the first user input terminal 5 and temporarily store the image in the memory 15. The imaging device 19 may also be operable to input biometric information such as an iris scan which may also be stored in the memory 15.

The user input device 17 may also comprise a touch sensitive input device 23 which is operable to enable a user to input personal identification information such as a signature and a fingerprint or a hand print. For example the touch sensitive device 23 may be operable to detect a user writing their signature on the touch pad with a stylus and may store this information in the memory 15.

The touch sensitive input device 23 may also be operable to input biometric information such as a finger print or a hand print. The touch sensitive device 23 may be operable to take a scan of a finger print or a hand print of a user when their finger or hand is positioned on the touch sensitive device 23. This information may also be temporarily stored in the memory 15.

The user input device 17 also comprises a device for entering alphanumeric data such as a key pad 21. The keypad 21 enables a user to enter alphanumeric personal identification information such as their name and address, their age or date of birth or the company with which they are associated.

The key pad 21 may also comprise keys which enable the user of the first user input terminal 5 to control the other input devices. For example the keypad 21 may comprise a key for controlling the imaging device 19 to capture an image of the user or a scan of the iris.

In some embodiments the user input device 17 may also comprise a voice recognition device which enables a user to control the terminal 5 using audio inputs. The user input terminal 5 may also be operable to provide instructions to the user of the terminal by audio outputs.

The user input device 17 may also comprise measuring devices 24 for inputting personal information such as a user's height and weight. The measuring devices 24 may comprise scales for measuring and inputting a user's weight. The measuring device 24 may also comprise means for measuring a user's height. For example, a sensor may be fitted in the top of the user input terminal 5 which is operable to determine the distance between the sensor and the top of the user's head by measuring the time it takes for an ultrasonic signal to be reflected from the top of the user input terminal 5 back to the sensor.

The key pad 21 may also be operable to allow a user to edit personal identification information which has been input, for example it may enable a user to correct errors in their personal identification information or to select an image from a plurality of images captured by the imaging device 19.

The first user input terminal 5 may also comprise a display 25 which is operable to display, to the user, personal identification information which has been input. The display 25 may also be operable to display instructions to a user of the terminal 5 instructing the user how to operate the terminal 5.

The first user input terminal 5 also comprises a key generating device 29. The key generating device 29 is operable to generate and issue a key 31 associated with the input personal identification information.

The key 31 is information that uniquely identifies the personal identification information. The key 31 may be alphanumeric information such as a password or number such as an eight digit number.

The key 31 may be stored on a card 33 which is issued by the key generating device 29. The key 31 may be the only information stored on the card 33.

The key 31 may be printed on the card 33 in a human readable format, for example a series of alphanumeric characters such as an eight digit number may be printed on the card 33. Alternatively the key 31 may be stored on the card 33 in a format which can only be read by a reading device. For example the key 31 may be stored in a magnetic strip, in a chip, in a barcode or in an RFID tag.

The transceiver 27 is operable to transmit the input personal identification information and the key 31 or information indicative of the key 31 to the central server 3 via the secure communications link 9.

The transceiver 27 may also be operable to receive information from the central server 3.

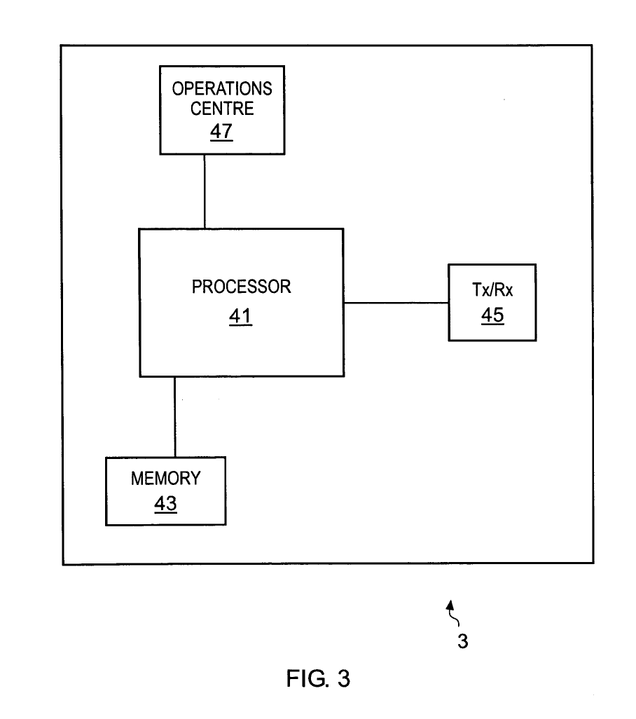

FIG. 3 schematically illustrates the central server 3 in more detail. The server 3 is operable to control the secure verification system 1.

The central server 3 comprises a processor 41, a memory 43, a transceiver 45 and an operations centre 47.

The processor 41 is operable to control the central server 3. The processor 41 is operable to receive and send input signals from the memory 43, the transceiver 45 and the operations centre 47.

The central server 3 comprises a memory 43 for storing the personal identification information which is input using the first user input terminal 5 and is then sent to the central server 3. The memory 43 is also be operable to store the key 31 or the information indicative of the key 31 which is also sent to the central server 3 from the first user input terminal 5.

The memory 43 may also be operable to store computer program instructions for controlling the central server 3.

The transceiver 45 enables the central server 3 to send and receive information from the plurality of first user input terminals 5 and the plurality of second user input terminals 7 via the secure communication links 9, 11.

The operations centre 47 enables a control user to control the administration of the system 1 from the central server 3.

The operations centre 47 may enable a control user to access the memory 43 and edit the personal identification information which is stored there. The personal identification information may be edited by changing the information stored, for example the name or address or replacing the stored image of the user with a new image. The personal identification information may also be edited by deletion, for example a user may no longer be authorised to access a restricted area so their personal identification information is no longer needed.

The operations centre 47 may also enable a control user to determine which areas of a system a user is authorised to access or the times at which the user is authorised to access particular areas.

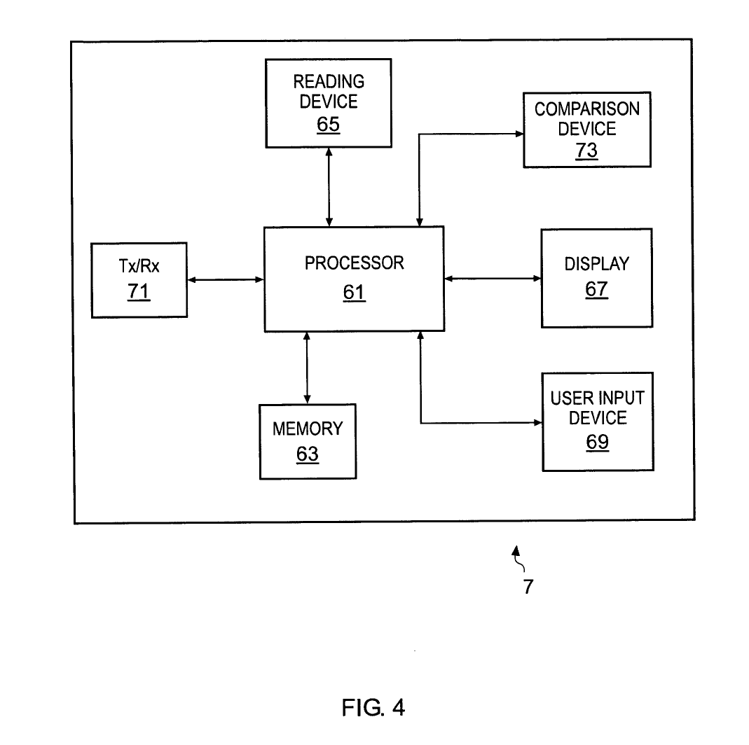

FIG. 4 schematically illustrates a second user input terminal 7 in more detail. The second user input terminal 7 enables the identity of a user of the secure verification system 1 to be verified.

The second user input terminal comprises a processor 61, a memory 63, a reading device 65, a display 67, a user input device 69, a transceiver 71 and a comparison device 73.

The processor 61 is operable to control the second user input terminal 7. The processor 61 is operable to receive and send inputs from the memory 63, the reading device 65, the display 67, the user input device 69 and transceiver 71 and the comparison device 73.

The memory 63 may store computer program instructions for controlling the second user input terminal 7.

The user input device 69 enables a user of the second user input terminal 7 to input information into the second user input terminal 7. The user input device 69 may comprise a keypad or a touch screen or any other device which enables a user to input alphanumeric information. In embodiments where the key 31 is alphanumeric information such as an eight digit number which is printed on the card 33 the user input device 69 may also enable a user to input the key 31 into the second user input terminal 7.

The second user input terminal 7 may also comprise a reading device 65. The reading device may be operable to read the key 31 from a card 33 in embodiments where the key 31 is stored in a format which cannot be read by a user, for example, in a magnetic strip, a barcode, a chip or an RFID tag. The reading device 65 may be operable to read more than one type of key 31.

The transceiver is operable to send and receive information from the central server 3 over the secure communications link 11.

The display 67 is operable to present information to the user. This information may be information which has been received from the server 3, information which is stored in the memory 63 or information which has been input by a user.

The comparison device 73 is operable to compare personal identification information retrieved from the central server 3 with a user of the second user input terminal 7 to determine whether or not the user of the second user input terminal 7 is an authorised user.

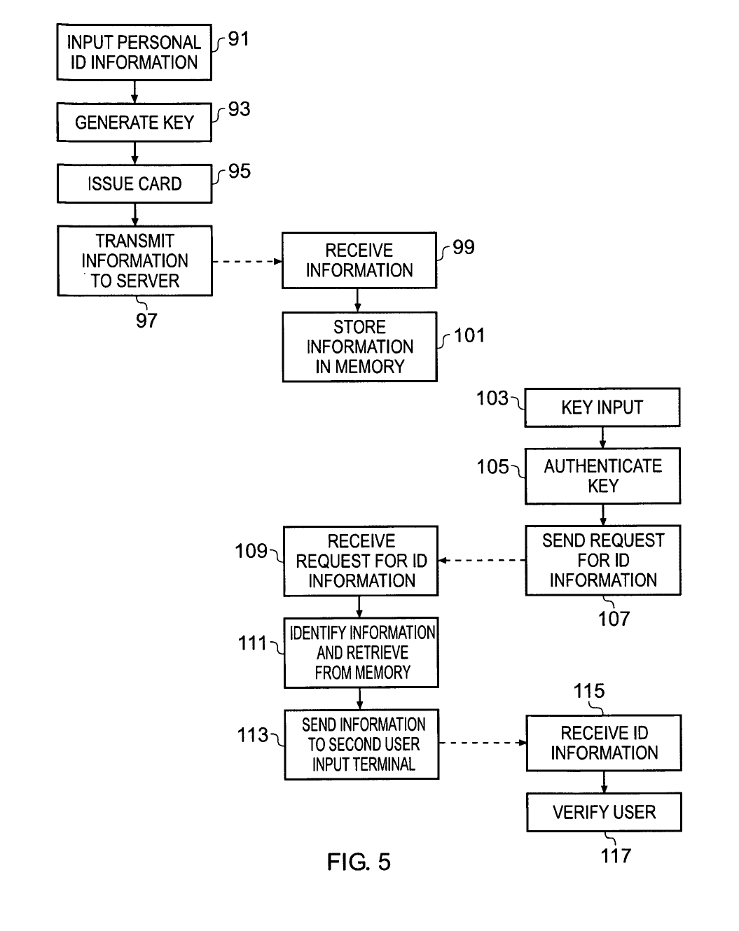

FIG. 5 illustrates a method of providing a secure verification system 1 according to an embodiment of the invention. In this particular embodiment steps 91 to 97 are carried out at a first user input terminal 5, steps 99, 101, 109, 111 and 113 are carried out at the central server 3 and steps 103 to 107 and steps 115 to 117 are carried out at a second user input terminal 7.

Steps 91 to 101 occur whenever a user inputs personal identification information into the secure verification system 1. For example when a new employee has joined a company and a new account of personal identification information needs to be created. Steps 103 to 117 occur whenever a user needs to be verified, for example when a user who has already set up an account of personal identification information wishes to enter a restricted access area.

At step 91 a user uses the input means 17 to input personal identification information at a first user input terminal 5. The personal identification information includes at least three different types of personal identification information. The personal identification information may include alphanumeric data such as a name and address, an image of the user, the height and weight of the user, biometric data such as an iris scan, a finger print or a hand print and a signature. In some embodiments the personal identification information will also include information obtained from a DNA sample of the user.

Once the necessary personal identification information has been input the key generating device 29 will generate, at step 93, a key 31 associated with the input personal identification information. The key 31 is then stored on a card 33 and the card 33 is issued to the user of the first input terminal 5 at step 95. The user of the first input terminal can then remove the card 33 and use it to verify their identity whenever they wish to access restricted areas.

At step 97 the first user input terminal 5 sends the input personal identification information and the key 31 or information indicative of the key 31 to the central server 3 via the secure communication link 9. It is to be appreciated that steps 95 and 97 may occur in either order or even simultaneously.

Once the personal identification information has been input by a user and sent to the central server 3 only control users with authorisation to use the operations centre 47 may edit or delete the personal identification information.

At step 99 the server 3 receives the input personal identification information and the key 31 or information indicative of the key 31 sent by the first user input terminal 5. The received information is stored in the memory 43 of the central server 3 at step 101.

At step 103 the key 31 is input into a second user input terminal 7. The key 31 may be input manually, for example a user may use the user input device 61 to key in alphanumeric information. Alternatively the reading device 65 may read the key 31 from the card 33.

At step 105 the second user input terminal 7 authorises the key 105 and confirms that it is an authentic key 31 which has been issued by a first user input terminal 5 of the system 1. At step 107 the second user input terminal 7 sends a request for the personal identification information associated with the key 31 to the central server 3.

At step 109 the central server 3 receives the request for the personal identification information associated with the key 31. The central server 3 identifies the personal identification information associated with the key 31. This may be done, for example, using a look up table. The identified personal identification information is then retrieved from the memory 43 of the central server 3 at step 111.

At step 113 the server 3 transmits the retrieved personal identification information to the second user input terminal 7 via the secure communications link 11 and at step 115 the personal identification information is received by the second user input terminal 7.

The received personal identification information is used to verify the identity of the user of the second user input terminal 7. The comparison device 73 compares the received personal identification information with the user of the second user input terminal 7. For example, it can take an iris scan of the user and compare this with the received iris scan or it can record the signature of the user and compare this with the received signature.

In some embodiments the verification of the identity of the user may also be manual. For example, some of the personal identification information such as the image may be presented on the display 67 of the verification terminal and an authorised control user of the second user input terminal 7 can use this image to verify that the user of the second terminal is an authorised person.

Embodiments of the invention thus provide a secure verification system where all the personal identification information is stored in a secure server 3 where it cannot be accessed by unauthorised persons. The key 31 which is issued by the system can only be used by the person whose personal identification information is associated with that key 31. If the user of the key 31 loses their card or has their card stolen then this does not compromise the security of the system as the card cannot be used anyone else.

Furthermore as the key 31 is generated by the system 1 the system 1 has a record of all keys 31. Therefore fake keys 31 and cards 33 cannot be used in an attempt to access the personal identification information or access a restricted area.

It is to be appreciated that various modifications can be made to the above described invention without departing from the scope of the invention as claimed.

In the above described embodiment each first user input terminal 5 comprises a key generating device 29 such that the key 31 is generated within the first user input terminal 5 and the key 31 or information indicative of the key 31 is transmitted from the first user input terminal 5 to the server for storage with the associated personal identification information. In an alternative embodiment the key generating device 29 may be comprised within the central server 3 so that the key 31 is generated within the central server 3 and then transmitted to the first user input terminal 5 where it is stored on a card 33 and issued to the user of the first user input terminal 5.

In some embodiments the first user input terminal 5 may also comprise a communications device for enabling the first user input terminal 5 to communicate in a communications network such as the internet or a telephone network. The keypad 21 or the touch sensitive display 23 may be operable to enable a user to control the communications device.

The first user input terminal 5 may also comprise means for enabling a user to make a copy of the information which has been input. For example the first user input terminal 5 may comprise a printer which enables a user to make a hard copy of the information. The first user input terminal 5 may also comprise means for loading the information onto a memory device such as a disk.

In the above described embodiments the operations centre 47 is comprised within the central server 3. In other embodiments the operations centre 47 may be separate from the central server 3 and may communicate with the central server 3 using a secure communications link.

In some embodiments of the invention the central server 3 may be operable to monitor the use of the system 1. The first user input terminals 5 and the second user input terminals 7 may be operable to record and store the time and date of events which occur at the terminals. For example, the first user input terminals 5 may be operable to record the date and time at which personal identification information is input and the second user input terminals 7 may be operable to record the date and time at which a user is identified. This information may be stored in the memories 15 and 63 of the respective terminals until it is requested by the central server 3. This information may then be made available to a control user of the operations centre 47 and be used to determine which user input terminals 5, 7 are used most often or the location of a user of the system at a specific time.

In some embodiments the user input terminals 5, 7 may also be operable to send information relating to the operation of the terminal itself. For example, the terminal may detect that a user input device is not functioning correctly and may send a report to the central server 3 to inform a control user of the operations centre 47 that maintenance may be needed on the terminal.

In the above described embodiments the verification of the identity of the user of the second user input terminal takes place at the second user input terminal 7. In other embodiments it may take place at the central server 3. For example, the second user input terminal 7 may comprise a user input device for inputting personal identification information. The newly input personal identification information is then transmitted to the central server 3 so that when the information associated with the users key 31 is retrieved it can be compared with the newly input information at the central server 3. The central server 3 can then transmit a message to the second user input terminal 7 indicating whether or not there is a satisfactory match between the newly input personal identification information and the retrieved personal identification information.

In some embodiments the second user input terminals 7 may be arranged to enable different levels of security to be employed at different locations or at different times. For example, there may be a low level of security in which the user of the second user input terminal 7 simply has to confirm alphanumeric information such as their name. In a different level of security the user of the second user input terminal may 7 simply have to have their image checked, this may be done electronically or by an authorised person, such as a security guard. For a higher level of security the user of the second user input terminal 7 may be required to match all of the pieces of personal identification information which are stored in the memory 43 of the central server 3.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/We claim:

1. A secure verification system comprising:
a first user input terminal, the first user input terminal comprising a user input device for enabling a user to input at least three different types of personal identification information and a transceiver for transmitting the input personal identification information;
a key generating device for generating and issuing a key associated with the input personal identification information wherein the key comprises information which is stored in a card which can be carried by a user of the verification system;
a server, the server comprising a transceiver for receiving and transmitting the personal identification information and information indicative of the key, storage means for storing the received personal identification information and the information indicative of the key associated with the received personal identification information; and
a second user input terminal comprising means for authenticating the issued key, means for retrieving the personal identification information associated with the key from the storage means and verification means for verifying the identity of the user of the second user input terminal using the personal identification information.

2. A system as claimed in claim 1, wherein the key generating device is comprised within the first user input terminal such that the key is generated at the first user input terminal.

3. A system as claimed in claim 2, wherein the transceiver of the first user input terminal is operable to transmit information indicative of the generated key to the server.

4. A system as claimed in claim 1, wherein the key generating device is comprised within the server such that the key is generated at the server.

5. A system as claimed in claim 4, wherein the transceiver of the first user input terminal is operable to receive information indicative of the generated key from the server.

6. A system as claimed in claim 1, wherein the personal identification information includes an image of the user of the first input terminal, a signature of the user of the first input terminal and at least one piece of biometric data of the user of the first input terminal.

7. A system as claimed in claim 1, wherein the key information is an eight digit number which is printed on the card.

8. A system as claimed in claim 1, wherein the card comprises a magnetic strip which stores the key information.

9. A system as claimed in any preceding claim 1 wherein the second user input terminal enables manual verification of the identity of the user.

10. A system as claimed in claim 1, wherein the first user input terminal is remote from the server.

11. A system as claimed in any preceding claim 1, wherein the second user input terminal is remote from the server.

12. A system as claimed in claim 10, wherein the remote user input terminals are connected to the server by a secure communications link.

13. A system as claimed in claim 1, comprising a plurality of first user input terminals.

14. A system as claimed in claim 1, comprising a plurality of second user input terminals.

15. A system as claimed in claim 1, wherein the server comprises means for enabling administration of the system.

16. A method of providing a secure verification system comprising;
inputting at least three different types of personal identification information at a first terminal;
generating and issuing a key associated with the input personal identification information wherein the key comprises information which is stored in a card which can be carried by a user of the verification system;
transmitting the personal identification information to a server;
storing the personal identification information and the information indicative of the associated key at the server;
authenticating the key at a second terminal; and
in response to the authentication of the key, retrieving the personal identification information associated with the key from the server and verifying the identity of the user of the second user input terminal using the retrieved information.

17. A method as claimed in claim 16, wherein the key is generated at the first terminal and information indicative of the key is transmitted from the first terminal to the server.

18. A method as claimed in claim 16, wherein the key is generated at the server and information indicative of the key is transmitted from the server to the first terminal.

19. A method as claimed in claim 16, wherein the personal identification information includes an image of the user of the first terminal, a signature of the user of the first terminal and at least one piece of biometric data of the user of the first terminal.

20. A method as claimed in claim 16 wherein the key information is an eight digit number which is printed on the card.

21. A method as claimed in claim 16 wherein the card comprises a magnetic strip which stores the key information.
